(19) United States
(12) Patent Application Publication
(10) Pub. No.: US 2007/0131097 A1
(43) Pub. Date: Jun. 14, 2007

(54) Method and system for regulating music based on the location of a device

(76) Inventors: Wei Lu, Tokyo (JP); Akikazu Otsuka, Inzai-shi (JP)

Correspondence Address: MOTOROLA INC, 600 NORTH US HIGHWAY 45, ROOM AS437, LIBERTYVILLE, IL, 60048-5343, US

(21) Appl. No.: 11/294,953

(22) Filed: Dec. 6, 2005

(51) Int. Cl. G10H 1/00; G10H 1/18; G10H 7/00

(52) U.S. Cl. 84/615

(57) ABSTRACT

A method and system for regulating music played by a mobile device based on a location of the device is useful for enhancing enjoyment and satisfaction derived from activities such as physical exercise programs. The method includes determining a first location of the mobile device (step 410), and playing a first music selection based on the first location of the mobile device (step 420). A second location of the mobile device is then automatically determined (step 425) and a second music selection is played based on the second location of the mobile device (step 435).

### FIELD OF THE INVENTION

The present invention relates generally to regulating features of music played by a mobile device based on the location of a user of the device. More particularly, although not exclusively, the invention relates to regulating a music tempo based on a person's location along an exercise route.

### BACKGROUND

Music is used frequently to boost athletic performance during physical training regimens. Listening to music also can add to the overall enjoyment of athletic activities, such as jogging, biking, walking, skiing and rowing. Participants in these activities often carry a portable digital audio player with them and listen to music through head phones or other small speakers associated with the music player.

Music selections played during an athletic activity are frequently tailored to a desired intensity of an activity. For example, a biker who seeks to push himself to the limits of his speed and endurance capabilities during a sprint ride, may choose to listen to a fast tempo music selection to provide motivation during the ride. On the other hand, someone walking for relaxation purposes may choose to listen to a relatively slow tempo music selection.

Portable electronic music players are often coupled with features of other consumer electronics products. For example a music player can be embedded in a device such as a mobile phone or a personal digital assistant (PDA). Features of such hybrid devices then can be combined to enhance a user's experience. Thus for example new music selections can be downloaded using wireless Over-The-Air (OTA) provisioning features of a mobile phone, and then played immediately over speakers or headphones attached to the phone.

Instant and accurate geographic location data is a further feature provided by many hybrid mobile electronic devices. Many handheld devices are able to access location data from the Global Positioning System (GPS) or from other mobile location systems, and couple the data with Geographic Information System (GIS) data. The combined location/GIS services are then employed for example in handheld navigation and locating systems.

### SUMMARY OF THE INVENTION

According to one aspect, the present invention is a method for regulating music played by a mobile device based on a location of the device. The method includes determining a first location of the mobile device, and then playing a first music selection based on the first location of the mobile device. A second location of the mobile device is then automatically determined and a second music selection is played based on the second location of the mobile device.

According to another aspect, the present invention is a system for regulating music played by a mobile device based on a location of the device. The system includes a microprocessor, a speaker operatively connected to the microprocessor, and a memory operatively connected to the microprocessor. The memory includes computer readable code for causing the microprocessor to: determine a first location of the mobile device, play through the speaker a first music selection based on the first location of the mobile device, automatically determine a second location of the mobile device, and play through the speaker a second music selection based on the second location of the mobile device.

Thus, according to particular embodiments of the present invention, music selections played by a mobile device can be changed automatically based on a location of the device. Enjoyment and satisfaction derived from activities such as physical exercise programs therefore can be enhanced, as athletes and other users can program a mobile device to change music selections at precise locations along a route, where both the locations and music selections correspond to a desired change in intensity of the activity.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating a radio communications device in the form of a mobile telephone that performs the present invention.

FIG. 2 is a schematic diagram illustrating graphics depicted on a display screen of a mobile phone, including a route line, according to an embodiment of the present invention.

FIG. 3 is another schematic diagram illustrating graphics depicted on a display screen of a mobile phone, including a route line, according to an embodiment of the present invention.

FIG. 4 is a general flow diagram illustrating a method for regulating music played by a mobile device based on a location of the device, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method and system for regulating music played by a mobile device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

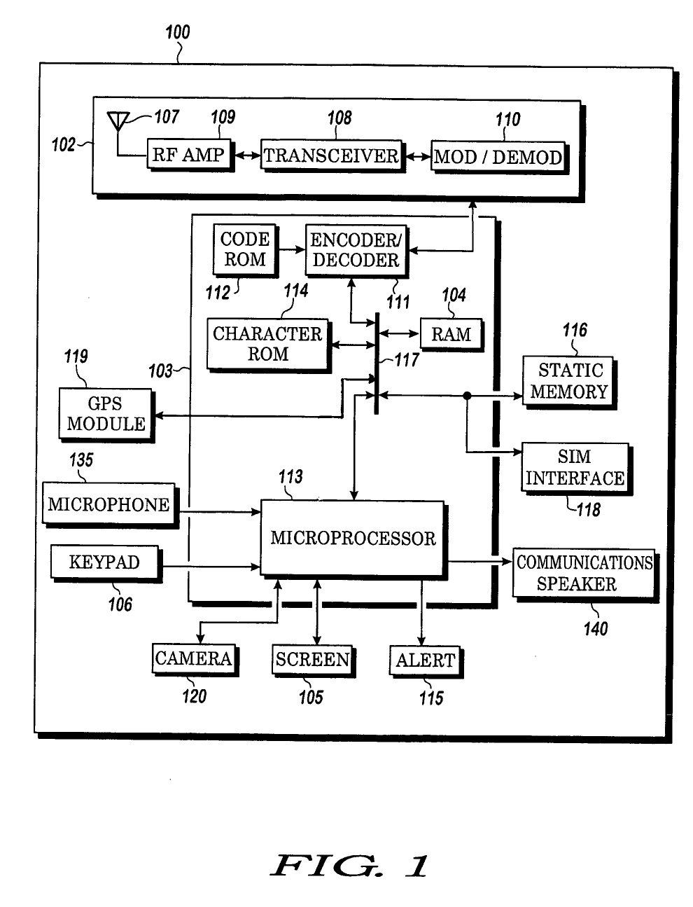

Referring to FIG. 1, there is a schematic diagram illustrating a radio communications device in the form of a mobile telephone 100 that performs the present invention. The telephone 100 comprises a radio frequency communications unit 102 coupled to be in communication with a processor 103. The mobile telephone 100 also has a display screen 105, a keypad 106 and a camera 120 coupled to be in communication with the processor 103. As will be apparent to a person skilled in the art, the screen 105 may be a touch screen thereby making the keypad 106 optional.

The processor 103 includes an encoder/decoder 111 with an associated code Read Only Memory (ROM) 112 storing data for encoding and decoding voice or other signals that may be transmitted or received by the radio telephone 100. The processor 103 also includes a microprocessor 113 coupled, by a common data and address bus 117, to the encoder/decoder 111, a character Read Only Memory (ROM) 114, a Random Access Memory (RAM) 104, static programmable memory 116 and a SIM interface 118. Also operatively connected to the bus 117 is a Global Positioning System (GPS) module 119 that includes a transceiver and other appropriate GPS circuitry.

The static programmable memory 116 and a SIM (often called a SIM card) operatively coupled to the SIM interface 118 each can store, among other things, selected incoming text messages and a Telephone Number Database TND (phonebook) comprising a number field for telephone numbers and a name field for identifiers associated with one of the numbers in the name field. For instance, one entry in the Telephone Number Database TND may be 91999111111 (entered in the number field) with an associated identifier “Steven C! at work” in the name field. The micro-processor 113 has ports for coupling to the screen 105, keypad 106 and camera 120, and an alert 115 that typically contains an alert speaker, vibrator motor and associated drivers. Also, microprocessor 113 has ports for coupling to a microphone 135 and communications speaker 140. The character ROM 114 stores code for decoding or encoding text messages that may be received by the communications unit 102. The character ROM 114 also can store operating code (OC) for the micro-processor 113 and code for performing functions associated with the radio telephone 100. Thus the ROM 114, RAM 104, static programmable memory 116 or SIM can comprise computer readable program code components that, when processed by the microprocessor 113, are configured to execute steps of a method of the present invention.

The radio frequency communications unit 102 is a combined receiver and transmitter having a common antenna 107. The communications unit 102 has a transceiver 108 coupled to antenna 107 via a radio frequency amplifier 109. The transceiver 108 is also coupled to a combined modulator/demodulator 110 that couples the communications unit 102 to the processor 103.

According to an embodiment of the present invention, the phone 100 can be employed to assist users during exercise regimens or other activities involving movement of the phone 100 from one place to another. First, music selections such as individual songs or music pieces, or portions of songs or music pieces, are stored in a memory associated with the phone 100, such as the static memory 116. As is known in the art, the phone 100 then can function as a portable digital audio player and the music selections can be played over the communications speaker 140, or other speakers such as headset speakers, attached to the phone 100. However, rather than playing a complete group of music selections in simple order or randomly, the present invention enables a user to program the phone 100 to play specified music selections at particular times or locations that correspond to a planned intensity of exercise of the user. Thus, according to the present invention, the phone 100 can function as an electronic “personal trainer,” providing musical motivation and enjoyment during an exercise program.

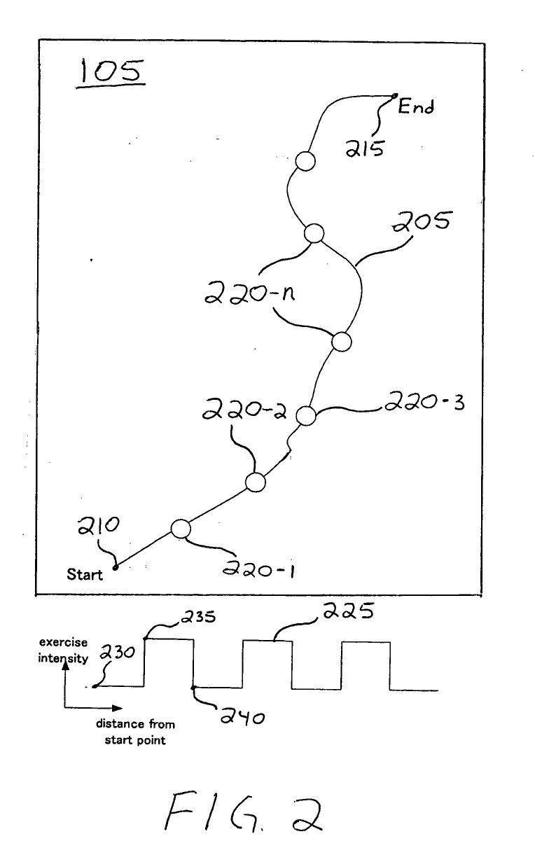

Referring to FIG. 2, a schematic diagram is illustrated of graphics depicted on the display screen 105 of the mobile phone 100, including a route line 205, according to an embodiment of the present invention. Using for example Geographic Information System (GIS) data stored in the static memory 116, the route line 205 can define an exercise route that overlays a map, such as a map of a city. Although not shown in FIG. 2, details of such a map including street names and landmarks also can be shown on the display screen 105. The route line 205 includes a start point 210, an end point 215, and a plurality of intermediate points 220-n. The intermediate points 220-n define locations along the route line 205 where a music selection that is played over the phone 100 is changed.

As an example, the square wave 225 shown below the screen 105 represents a typical exercise regimen where an athlete cycles between periods of high intensity and exertion, and periods of lesser intensity and exertion. Exercise intensity is thus shown along the vertical axis and a distance from the start point 210 is shown along the horizontal axis. Thus a user may begin exercising at the location identified by the start point 210 at a moderate level of exertion identified by point 230, and where a first music selection such as a moderate tempo song is played by the phone 100. The phone 100 then automatically determines the first intermediate point 220-1 based on a parameter input by the user. For example the user may have input into the phone a request for a square wave exercise regimen having a period of one mile. The phone 100 then automatically determines that the location of intermediate point 220-1, corresponding to point 235 on the square wave 225, is one half mile from the start point 210, and that a higher intensity level of exercise is now required. Thus at point 220-1 the phone automatically switches to a second music selection such as a fast tempo song. Next, when the user reaches the second intermediate point 220-2, he or she has pre-programmed the phone 100 to indicate that a moderate intensity level of exercise is again required, corresponding for example to point 240 on the square wave 225. Thus at point 220-2 the phone automatically switches back to the first music selection or to another moderate tempo song. Such a cycle continues as the user progresses through the route line 205 to a third intermediate point 220-3 and to other intermediate points 220-n until reaching the end point 215.

The route line 205 can correspond to any type of travel route such as a biking, jogging, walking, horse riding, swimming, skiing or rowing route. A route line 205 can be easily programmed into a phone 100 using techniques such as typing in latitude and longitude coordinates or by simply drawing, using a finger or stylus, a route line 205 onto a map shown on a touch screen display 105.

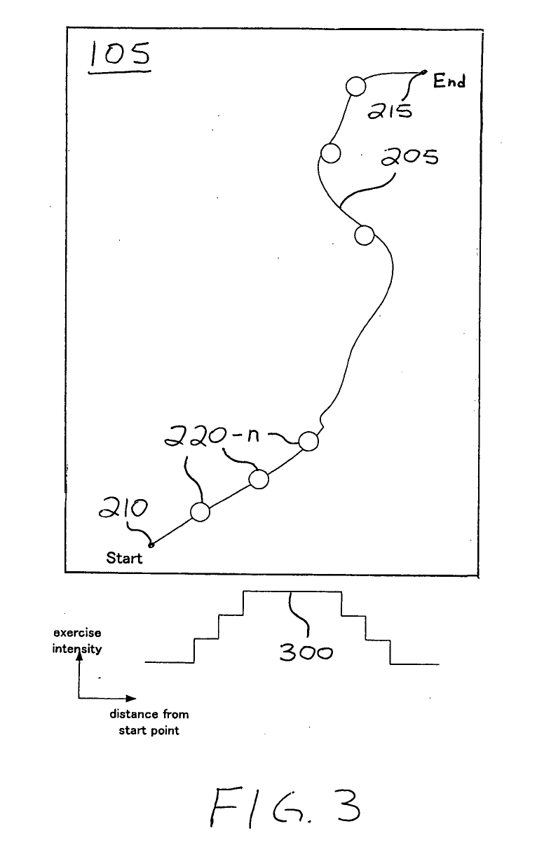

Referring to FIG. 3, another schematic diagram is illustrated of graphics depicted on the display screen 105 of the mobile phone 100, including the route line 205, according to an embodiment of the present invention. Here, another type of exercise regimen, a typical “stair-step” program that incrementally increases in intensity and then incrementally decreases in intensity, is illustrated by the stepped plot 300. Programmed intensity changes between steps again correspond to intermediate points 220-n along the route line 205, and are indicated to a user of the phone 100 by changes in music selections.

Music selections according to the present invention can be any type of audio or multimedia presentation, including videos displayed on the screen 105. Music selections can correspond to entire songs or other musical pieces, or to segments of songs or other musical pieces. Other embodiments of the present invention can include changing a music feature such as the key, tempo, rhythm, beat or volume, of a single musical composition, such as a classical music piece, at discrete points 220-n. According to the vocabulary used in this specification, each such change in a music feature can be considered as a different music selection.

Those skilled in the art will appreciate that the phone 100 can acquire its precise location along a route line 205 using, for example, mobile positioning data from mobile base stations or from GPS satellites communicating with the GPS module 119. The mobile positioning data is coupled with Geographic Information System (GIS) data to define locations relative to geographic indicators, such as address data, road or city names, or nearby landmarks that are depicted on a map shown on the display screen 105.

Also, embodiments of the present invention can calculate derivatives from mobile positioning data to determine velocities of the phone 100. Thus changes in music selections can be made based on changes in a velocity of a user. For example, when a biker accelerates to a particular velocity, a fast tempo, rock genre song may begin playing automatically over the phone 100. Then when the biker decelerates to another velocity the phone 100 automatically begins to play a slower tempo, classical genre music selection. Such velocity-based changes to music selections can correspond to any point on a route line 205, or can be programmed independently of a route line 205.

After a user identifies a route line 205, the user can simply select a type of exercise program, corresponding for example to the square wave 225 or stepped plot 300, and the phone 100 will automatically determine the locations of various intermediate points 220-n along the route line 205. Locations such as intermediate points 220-n also can be determined independent of a route line 205. For example a user can simply program a route parameter that is location-independent, for example a specified total exercise distance or time, into the phone 100. The phone 100 then automatically determines associated intermediate points 220-n where music selections are changed. For example an automatically determined intermediate point 220-n can correspond to a halfway point along an arbitrary route that is defined only by a total distance. Other intermediate points 220-n along arbitrary routes can be determined based on a percentage of a total distance of a route, or based on an estimated time for traveling a route.

Still other embodiments of the present invention can assist a user in navigating a route line 205, such as by providing directions or other comments concerning a route line 205. For example, voice guides such as synthesized speech or recorded voice files can be used to indicate to a user that a halfway point has been reached, that a left turn is required ahead, or that a wrong turn has been made and that the user should turn around. Other voice guides can indicate for example a level of calorie consumption or a distance remaining along a route line 205.

Those skilled in the art will also recognize that the present invention is not limited to use on mobile phones 100, but can be implemented on various types of electronic devices, including dedicated portable digital audio players and personal digital assistants (PDAs).

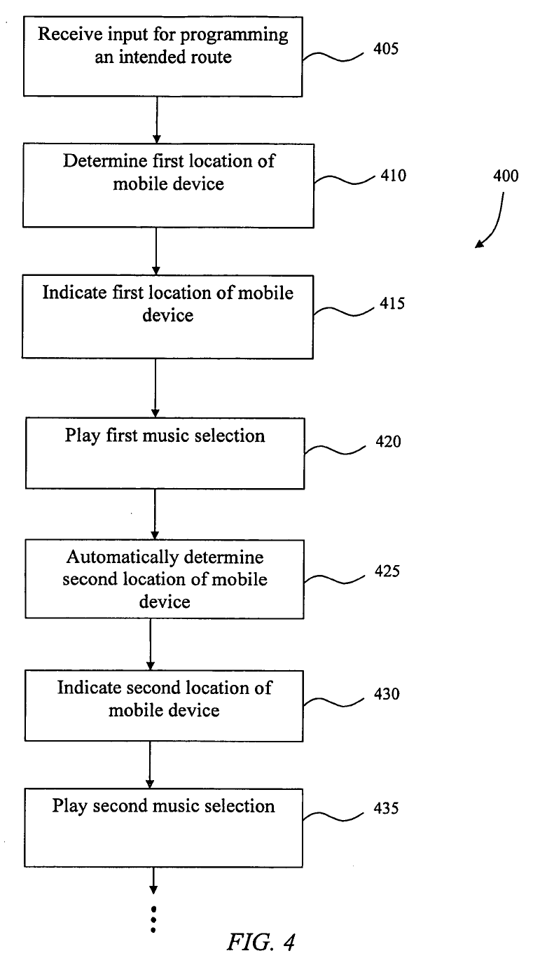

Referring to FIG. 4, a general flow diagram is illustrated of a method 400 for regulating music played by a mobile device based on a location of the device, according to an embodiment of the present invention. At step 405, the mobile device receives input for programming an intended route. For example, as described above, a route line 205 can be plotted on a map that is shown on a display screen 105 of the mobile phone 100. At step 410, a first location of the mobile device is determined. For example, the phone 100 can determine using its GPS module 119 that it is located at a start point 210 on a route line 205. At step 415 the first location of the mobile device is indicated to a user, such as through information displayed on the display screen 105. Next, at step 420, a first music selection is played, such as through a speaker 140 operatively connected to the phone 100, based on the first location of the mobile device. Thus if the start point 210 corresponds to an exercise warm-up period, a moderate tempo, relaxing first musical selection may be played. At step 425, a second location of the mobile device is automatically determined by the mobile device. For example, the phone 100 can automatically calculate a first intermediate point 220-1 on a route line 205 based on a parameter input by the user, and then identify that it is located at the first intermediate point 220-1. At step 430 the second location of the mobile device is indicated to a user. Then at step 435 the mobile device plays a second music selection, such as a faster tempo selection that corresponds to a desired higher intensity interval of an exercise program. The method 400 then continues where a plurality of additional locations is automatically determined, and a plurality of additional music selections is played based on, respectively, the plurality of additional locations. For example the method 400 continues through a series of additional intermediate points 220-n along a route line 205, until an end point 215 is reached.

Advantages of embodiments of the present invention thus include the ability to automatically change music selections played by a mobile device based on a location of the device. Enjoyment and satisfaction derived from activities such as exercise programs therefore can be enhanced, as athletes and other users can program a mobile device to change music selections at precise locations along an exercise route, where both the locations and music selections correspond to a desired change in exercise intensity. Using GIS and mobile positioning data, users are able to intuitively plot routes on a display screen 105. Intermediate locations along an intended route, where a user desires a music selection to change, are then automatically determined by the mobile device. The present invention thus can function as an electronic “personal trainer,” providing motivation, directions, and other helpful information during an exercise program.

It will be appreciated that embodiments of the invention described herein may be comprised of one or more conventional processors and unique stored program instructions that control the one or more processors to implement, in conjunction with certain non-processor circuits, some, most, or all of the functions of regulating music played by a mobile device as described herein. The non-processor circuits may include, but are not limited to, a radio receiver, a radio transmitter, signal drivers, clock circuits, power source circuits, and user input devices. As such, these functions may be interpreted as steps of a method for regulating music played by a mobile device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for regulating music played by a mobile device based on a location of the device, the method comprising:
determining a first location of the mobile device;
playing a first music selection based on the first location of the mobile device;
automatically determining a second location of the mobile device; and
playing a second music selection based on the second location of the mobile device.

2. The method of claim 1, further comprising receiving input for programming an intended route, where the route includes a plurality of locations including the first and second locations.

3. The method of claim 1, wherein the music selections correspond to a planned intensity of exercise of a user of the mobile device, and a key, tempo, rhythm, beat, or volume of the second music selection is different from a key, tempo, rhythm, beat, or volume of the first music selection.

4. The method of claim 1 further comprising determining a plurality of additional locations of the mobile device and playing a plurality of additional music selections based on, respectively, the plurality of additional locations.

5. The method of claim 1 wherein a map including representations of the first and second locations is displayed on a screen of the mobile device using both Geographic Information System (GIS) data and mobile positioning data.

6. The method of claim 1, wherein the first location of the mobile device is used to calculate a first velocity of the mobile device, and the second location of the mobile device is used to calculate a second velocity of the mobile device.

7. The method of claim 1, further comprising indicating to a user of the mobile device a current location of the mobile device relative to an intended route.

8. The method of claim 1, wherein an identity of the second location is calculated automatically by the mobile device based on a parameter of an intended route that is selected from the group consisting of: a halfway point, a percentage of a total distance of the route, and an estimated time for traveling the intended route.

9. A system for regulating music played by a mobile device based on a location of the device, the system comprising:
a microprocessor;
a speaker operatively connected to the microprocessor; and
a memory operatively connected to the microprocessor, wherein the memory includes computer readable code for causing the microprocessor to:
determine a first location of the mobile device;
play through the speaker a first music selection based on the first location of the mobile device;
automatically determine a second location of the mobile device; and
play through the speaker a second music selection based on the second location of the mobile device.

10. The system of claim 9, wherein the memory further includes computer readable code for causing the microprocessor to program an intended route that includes a plurality of locations, including the first and second locations.

11. The system of claim 10, wherein the intended route is programmed based on user input received through a touch screen, keypad, or microphone operatively connected to the microprocessor.

12. The system of claim 9, wherein the music selections correspond to a planned intensity of exercise of a user of the mobile device, and a key, tempo, rhythm, beat, or volume of the second music selection is different from a key, tempo, rhythm, beat, or volume of the first music selection.

13. The system of claim 9, wherein the memory further includes computer readable code for causing the microprocessor to determine a plurality of additional locations of the mobile device and play through the speaker a plurality of additional music selections based on, respectively, the plurality of additional locations.

14. The system of claim 9 further comprising a display screen operatively connected to the microprocessor, wherein a map including representations of the first and second locations is displayed on the screen using both Geographic Information System (GIS) data and mobile positioning data.

15. The system of claim 9, wherein the memory further includes computer readable code for causing the microprocessor to use the first location of the mobile device to calculate a first velocity of the mobile device, and use the second location of the mobile device to calculate a second velocity of the mobile device.

16. The system of claim 9, wherein the memory further includes computer readable code for causing the microprocessor to indicate to a user of the mobile device a current location of the mobile device relative to an intended route.

17. The system of claim 9, wherein an identity of the second location is calculated automatically by the microprocessor based on a parameter of an intended route that is selected from the group consisting of: a halfway point, a percentage of a total distance of the route, and an estimated time for traveling the intended route.

18. The system of claim 9, wherein the device is a mobile phone, digital audio player, or personal digital assistant.

19. A system for regulating music played by a mobile device based on a location of the device, the system comprising:
means for determining a first location of the mobile device;
means for playing a first music selection based on the first location of the mobile device;
means for automatically determining a second location of the mobile device; and
means for playing a second music selection based on the second location of the mobile device.
